(19) United States
(12) Patent Application Publication
(10) Pub. No.: US 2014/0209397 A1
(43) Pub. Date: Jul. 31, 2014

(54) DRIVE UNIT FOR AN ELECTRIC VEHICLE AND METHOD FOR DEFINING A DRIVE UNIT IN AN ELECTRIC VEHICLE

(71) Applicant: Daniel Wolf, Friedrichshafen (DE)

(72) Inventor: Daniel Wolf, Friedrichshafen (DE)

(73) Assignee: ZF FRIEDRICHSHAFEN AG, Friedrichshafen (DE)

(21) Appl. No.: 14/240,750

(22) PCT Filed: Aug. 2, 2012
(86) PCT No.: PCT/EP2012/065108

§ 371 Date: Feb. 25, 2014

(30) Foreign Application Priority Data
Sep. 9, 2011 (DE) 10 2011 082 391.3

(51) Int. Cl. B60K 1/00

(52) U.S. Cl. CPC B60K 1/00
USPC 180/65.1; 29/592.1

(57) ABSTRACT

A drive unit for an electric vehicle with an electric machine for driving an axle of the electric vehicle. The electric machine is arranged in a housing with a driveshaft for transmitting torque from the electric machine to an axle of the electric vehicle. At least one mounting system is provided for mounting the drive unit to a body of the electric vehicle. The housing (1a) of the drive unit is designed as the mounting system for the drive unit on a body of the electric vehicle. A method for fixing a drive unit in an electric vehicle, and a drive system for an electric vehicle with a drive unit are also disclosed.

This application is a National Stage completion of PCT/EP2012/065108 filed Aug. 2, 2012, which claims priority from German patent application serial no. 10 2011 082 391.3 filed Sep. 9, 2011.

### FIELD OF THE INVENTION

The invention concerns a drive unit for an electric vehicle with an electric machine for driving the electric vehicle, wherein the machine is arranged in a housing, and with a driveshaft for transmitting a torque from the electric machine to an axle of the electric vehicle, and with at least one mounting system for mounting the drive unit on a vehicle body of the electric vehicle.

The invention also concerns a method for fixing a drive unit in an electric vehicle and a drive system for an electric vehicle.

### BACKGROUND OF THE INVENTION

Drive units for electric vehicles generally comprise an electric motor with a driveshaft which, by way of a transmission, ultimately drives a wheel or wheels of the electric vehicle. Instead of a central internal combustion engine positioned above the front axle as in conventionally powered motor vehicles, a central electric motor can be arranged for driving the front axle. Moreover, so-termed wheel drives have also become known, for example from U.S. Pat. No. 6,540,632 B1. Furthermore, from DE 100 22 319 A1 an electric drive of so-termed transaxle design has become known. In that case, instead of the axle drive or differential, an electric machine with a differential is provided, which drives the wheels of an axle of the electric vehicle by way of Cardan shafts. The electric machine and the differential are arranged, for their mounting, in an auxiliary frame which is rigid in every spatial direction, in particular by means of bearing bushes. In turn, the auxiliary frame is itself arranged on a vehicle body of the electric vehicle. It is also known to connect the electric machine to the vehicle body with its associated differential in a laterally fixed position, i.e. essentially by arranging the electric machine with its driveshaft perpendicular to the vehicle axis.

The disadvantage of this is that on the one hand more fitting space is needed, in particular due to the auxiliary frame, in order to fix or mount the drive unit with its motor and transmission on the vehicle body. On the other hand, due to the restricted fitting space available at the respective axles of the electric vehicle, the production and fitting of the drive unit in the electric vehicle are difficult and complicated, so that manufacturing costs are increased.

### SUMMARY OF THE INVENTION

Accordingly, an objective of the present invention is to provide a drive unit for an electric vehicle, which can be produced inexpensively, takes up less fitting space and can be fitted in a simple and reliable manner into an electric vehicle for driving it.

The invention achieves that objective by means of a drive unit for an electric vehicle, with an electric machine for driving the electric vehicle, which is arranged in a housing, with a driveshaft for transmitting drive torque from the electric machine to an axle of the electric vehicle, and with at least one mounting system for mounting the drive unit on a body of the electric vehicle, wherein the housing of the drive unit is designed as the mounting system for fixing the drive unit onto the body of the electric vehicle.

The invention also achieves the objective by virtue of a method for fixing a drive unit in an electric vehicle, in particular according to the following steps: at least one spring link is fitted into a recess of a housing of the drive unit and the at least one spring link is fixed in the recess by bracing it therein and/or by screwing on a plate.

The invention also achieves the objective by virtue of a drive system for an electric vehicle, with a drive unit having at least one cross-member on which the housing of the drive unit is fixed, and at least one spring link fixed on the one hand to the housing of the drive unit, and on the other hand to a fixing element of the body of the electric vehicle, in particular a longitudinal member.

An advantage achieved with the invention is that it provides a drive unit and a drive system for an electric vehicle, in particular for a rear axle of an electric vehicle, wherein the mounting system, the chassis link and/or the housing of the drive unit and its transmission together form a functional unit. In this case the housing of the drive unit functions as an auxiliary frame for mounting the drive unit in the electric vehicle, so that there is no need for an elaborate auxiliary frame that takes up a lot of space.

Expediently, the housing comprises at least one first fixing means for fixing at least one, in particular elastic spring link of the electric vehicle to the housing. The advantage achieved by this is that, in a simple and reliable manner, the housing of the drive unit provides fixing means so that, in the sense of an auxiliary frame, the housing can be connected as a mounting system to the body of the electric vehicle. Thus, by virtue of the in particular elastic spring link, certain elasticities in various spatial directions can be provided for the drive unit, in order to selectively suppress vibrations of the drive unit, at least partially.

Advantageously, the at least one first fixing means are designed for fixing a through-going, in particular elastic spring link. The spring links can then simply be inserted into the housing of the drive unit and, by closing the housing, held reliably and firmly in the housing of the drive unit. This also enables the housing of the drive unit to be produced particularly simply and inexpensively, since a through-going spring link also has to be fixed only at one position of the housing. Elaborate further fixing positions of the spring link, for example on various sides of the drive unit housing, can therefore be omitted.

Expediently, the first fixing means comprise a conical opening for receiving the spring link, which opens toward the inside of the housing, If the spring links are designed with a corresponding, essentially conical shape, then without additional fixing means they can be fixed by the housing of the drive unit, in the drive unit housing itself, in a form-locked and/or friction-locked manner. Additional bores or the like for fixing the spring link can be omitted, so that the drive unit can be produced even more inexpensively. Moreover, the conically converging openings can also be produced at the same time as the housing of the drive unit by means of an appropriate casting mold, and do not therefore have to be subsequently formed in the housing, for example by milling or some other method.

Advantageously, the first fixing means are designed to receive the spring link in a plug-in manner. This enables particularly simple insertion and fixing of the spring link in the drive unit housing. To do this, the drive unit housing does not have to be opened, but can first be fitted in the electric vehicle. Once the transmission has been fitted in the vehicle, the spring link can then be inserted into the housing and thereby also fixed to it. Overall, this substantially simplifies the production of the electric vehicle.

Expediently, the first fixing means are designed for fixing a spring link made of a fiber-plastic composite material. This enables reliable fixing by the first fixing means, of elastic and lightweight spring links made of fiber-plastic composite material, to the drive unit.

Advantageously, a plurality of first fixing means are arranged substantially parallel to the driveshaft and one above another and/or offset relative to one another. The advantage of this is that greater torsional rigidity of the drive unit relative to the vehicle body of the electric vehicle is achieved with such an arrangement of the first fixing means in the housing of the drive unit. A mutually offset arrangement of the first fixing means one above another is better able to support torque acting perpendicularly to the driveshaft, in particular that of the electric machine, by means of the spring links positioned in the first fixing means; in this way, tilting of the electric machine can be avoided.

Expediently, the housing has second fixing means for fixing the housing to a cross-member of the electric vehicle. This enables a still more reliable mounting of the drive unit on the body of the electric vehicle. By way of the second fixing means, part of the torque produced by the drive unit perpendicularly to the driveshaft can likewise be supported, for example when the cross-member of the electric vehicle is arranged perpendicularly to the plane established by the cross-member and the driveshaft of the drive unit.

Advantageously, the second fixing means are designed to fix the cross-member in a form-locked and/or friction-locked manner. This enables particularly simple and reliable fixing of the drive unit to the cross-member of the electric vehicle, for example by clamping or bracing the cross-member to the drive unit.

Expediently, a torque support is arranged on the housing, in particular projecting perpendicularly to the driveshaft. By virtue of this torque support the drive unit can on the one hand be indirectly fixed still more reliably to the body of the electric vehicle, while at the same time a torque difference of the drive unit between its drive input and drive output can be supported on the body of the electric vehicle.

Advantageously, the torque support comprises a sleeve joint for fixing to a stabilizer of the electric vehicle, which in particular is made of rubber. This enables the drive unit to be simply and reliably supported on the stabilizer of the electric vehicle.

Expediently, the sleeve joint has recesses. The advantage of this is that, similarly to a chassis comfort mounting, different rigidities are enabled in directions perpendicular to the driveshaft.

Further important features and advantages of the invention emerge from the drawings and from the description of figures with reference to the drawings.

It is understood that the characteristics mentioned above and those still to be explained, can be used not only in the combination indicated in each case, but also in other combinations or as stand-alone features, without going beyond the scope of the present invention.

### BRIEF DESCRIPTION OF THE DRAWINGS

Preferred example embodiments of the invention are illustrated in the drawings and will be explained in more detail in the description given below, wherein the same indexes refer to the same, or similar or functionally equivalent components or elements. The drawings show, in each case schematically:

FIG. 1: A drive assembly with a drive unit, according to a first embodiment of the present invention, viewed from above;

FIGS. 2a, 2b: Cross-sections through a housing of the drive unit, according to the first embodiment; and

FIG. 3: A three-dimensional, perspective view of the drive assembly in FIG. 1.

### DETAILED DESCRIPTION OF THE PREFERRED EMBODIMENTS

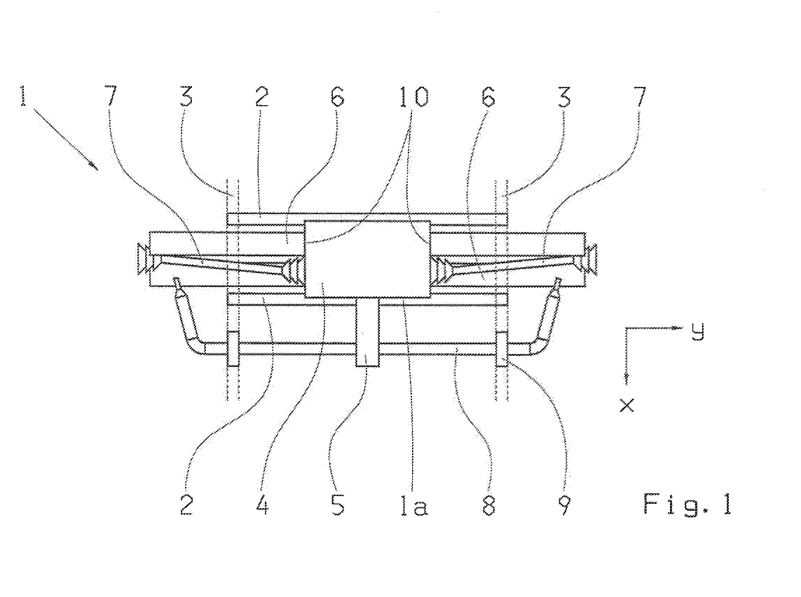

FIG. 1 shows a drive assembly with a drive unit, according to a first embodiment of the present invention, viewed from above.

In FIG. 1 the index 1 denotes a drive unit for an electric vehicle. The drive unit 1 comprises an electric motor 4 arranged in a housing 1a of the drive unit 1. As shown in FIG. 1, the housing 1a of the drive unit 1 is of essentially rectangular shape with its longer sides each arranged on a respective cross-member 2 of a body of the electric vehicle. The cross-members 2, in turn, are connected to longitudinal members 3 of the body of the electric vehicle that extend parallel to the axis of the electric vehicle. In order to drive wheels of the electric vehicle (not shown), the drive unit 1 is connected to Cardan shafts 7 that are arranged on both the left and right, in the y-direction shown in FIG. 1. To mount the drive unit 1, elastic spring links 6 made of a fiber-plastic composite material are provided, which are fixed in lateral housing openings 10 of the housing 1a and are arranged essentially parallel to the Cardan shafts 7. The spring links 6 also extend essentially in the y-direction toward the wheels of the electric vehicle, and in this case are each separate from one another, i.e. not in the form of a through-going component through the housing 1a of the drive unit 1, being fitted separately in the housing 1a of the drive unit 1. In all, therefore, FIG. 1 shows four spring links 6, in each case two of them parallel to one another on the left and right sides of the drive unit 1. The housing openings 10 taper conically outward and the spring links 6 are in this case designed such that after being positioned in the housing 1a and after the housing 1a has been closed by bolting, they are gripped in the conical housing openings 10 and thereby fixed. Needless to say, the spring links 6 can also be inserted from outside into the housing 1a, and alternatively or in addition, fixed by means of a flange plate from outside onto or in the housing 1a of the drive unit 1.

The cross-members 2 are also fixed to the housing 1a of the drive unit 1: in FIGS. 1 to 3 the cross-members 2 are clamped in corresponding recesses 14 on the outside of the housing 1a and therefore connected by interlock and friction force to the housing 1a and the drive unit 1.

The housing 1a of the drive unit 1 is preferably made of aluminum, in particular cast aluminum, and preferably comprises a profile 11 and/or a number of separation planes toward its center. The center is denoted as essentially half of the extension of the longer sides of the rectangular housing 1a. The housing 1a also has a torque support 5, which in FIG. 1 projects in the x-direction or downward, As shown in FIG. 1 the torque support 5 is arranged essentially centrally relative to a stabilizer 8 of the electric vehicle.

The torque support can on the one hand be arranged close to the center of the length of the stabilizer 8 in the y-direction, in order to distribute loads uniformly to lateral stabilizer mountings 9 arranged perpendicularly to the driveshaft at the level of the longitudinal members 3 of the vehicle body. It is also possible, however, to arrange the torque support 5 asymmetrically on the stabilizer 8 with the torque support 5 on the stabilizer 8 closer to one of the stabilizer mountings 9. That stabilizer mounting 9 is then made correspondingly stronger so as to be able to withstand the consequently higher loads. A rubber sleeve joint is inserted between the torque support 5 and the stabilizer 8. This has recesses so as to have different rigidities in different spatial directions. For example, it can be made more rigid parallel to the length of the longitudinal member 3 in order to prevent relative displacement of the stabilizer 8 and the drive unit 1 when the electric motor 4 of the drive unit 1 is actuated. At the same time the rigidity can be made softer or weaker perpendicularly to the figure plane of FIG. 1 so that when the drive unit 1 is actuated for the electric vehicle, the torque support is flexibly supported on the stabilizer 8,

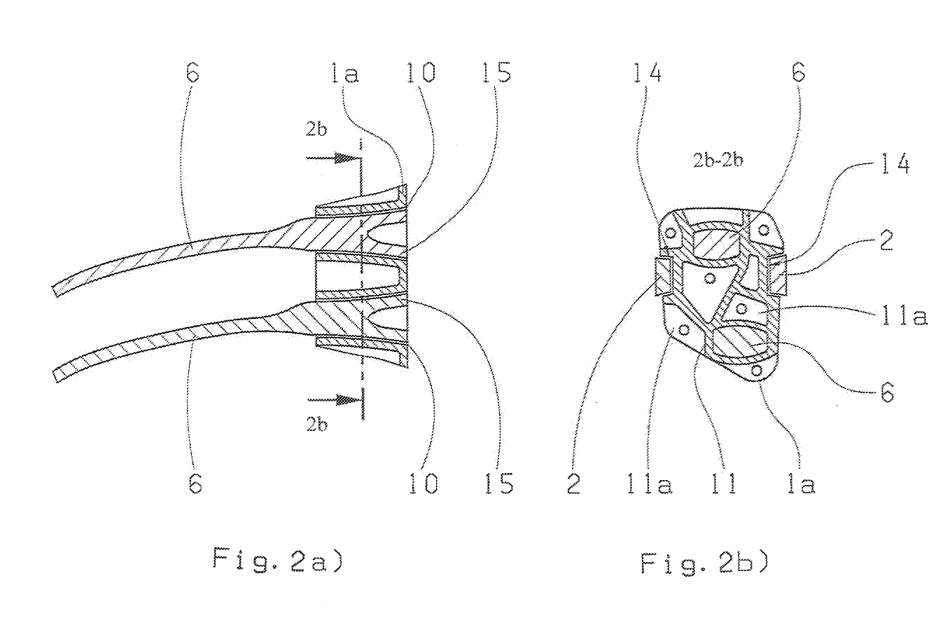

FIG. 2 shows cross-sections through a housing of the drive unit according to the first embodiment.

FIG. 2a shows a cross-section perpendicular to the figure plane of FIG. 1 through the housing 1a of the drive unit. The figure shows two conically shaped housing openings 10 arranged one above the other, which broaden out toward the inside of the housing 1a. The spring links 6 are inserted in the housing openings 10 and are designed so that they can be inserted into the housing openings 10 from the outside and thereby fixed: as shown in FIG. 2a these have V-shaped expansion elements 15 which correspond to the conical housing openings 10 of the housing 1a. In this way, once the housing 1a has been closed the spring links 6 cannot slip or slide out of the housing openings 10 and are held firmly with and in the housing 1a.

FIG. 2b shows a section along the section line 2b-2b in FIG. 2a. The section line 2b-2b corresponds to the y-direction in the figure plane of FIG. 1. On the outside of the housing 1a can be seen two recesses 14 into which, on the left and right sides, the cross-member 2 is pressed and thus fixed. This can also be held firmly in the housing 1a by additional fixing means in the recesses 14. Inside the housing 1a, a profiling 11 with free spaces 11a can be seen, which on the one hand makes the housing 1a more rigid and on the other hand has a damping effect on vibrations of the electric motor 4.

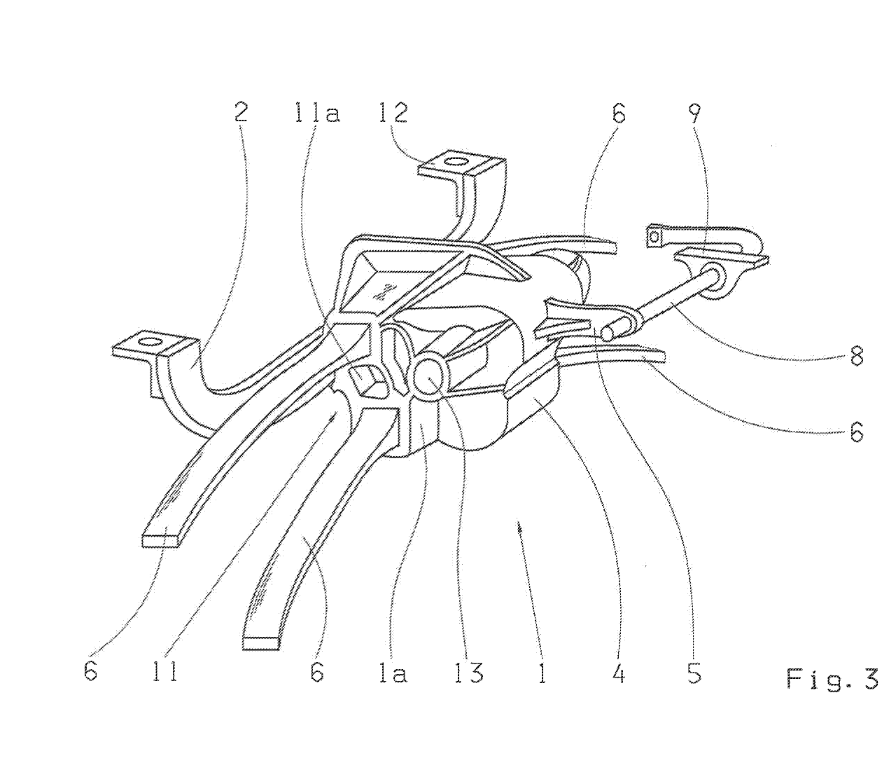

FIG. 3 shows a three-dimensional, perspective view of the drive assembly according to FIG. 1.

FIG. 3 shows the drive unit 1 according to FIGS. 1, 2a and 2b in a three-dimensional view. In the front, i.e. the lower, left-hand area of FIG. 3 can be seen two spring links 6, which are fixed in the housing 1a of the drive unit 1. Also visible is the profiling 11 of the housing 1a with its free spaces 11a. An electric motor 4 is also shown, which is arranged in the housing 1a of the drive unit 1 and has a drive output shaft 13 which extends essentially parallel to the length of the spring links 6 in the direction toward wheels of the electric vehicle. Perpendicularly from the upward-extending side of the housing 1a facing away from the spring links 6 is arranged the torque support 5, which is connected to a stabilizer 8. The stabilizer 8 extends parallel to a vehicle axle of the electric vehicle (in the y-direction in FIG. 1) and is mounted in stabilizer mountings 9 (upper right-hand area of FIG. 3. On the side facing away from the electric motor 4, i.e. the part of the housing 1a in which, essentially, the spring links 6 are arranged, the housing 1a is connected by friction force to a cross-member 2 as shown in FIG. 2b. Over its full length the cross-member 2 is essentially U-shaped perpendicularly to the electric vehicle axle and open upward, and at its ends has fixing brackets 12 enabling it to be fixed to a longitudinal member 3 of the vehicle body (not shown in FIG. 3).

If the cross-member 2 is for example designed to be torsionally rigid relative to the body of the electric vehicle, in particular as a hollow-profiled braided tube, and is appropriately attached to the body, then there is no need for a torque support 5 since the cross-member 2 itself essentially functions as a torque support. If the cross-member 2 is made rigid perpendicularly to the figure plane of FIG. 1 the torque support can even be arranged flexibly at various points on the vehicle body.

Overall, the invention has among other things the advantage that the use of a costly and bulky auxiliary frame for mounting the drive unit on a body of the electric vehicle can essentially be dispensed with. The housing of the drive unit takes over the function of an otherwise necessary auxiliary frame for mounting the drive unit on the body of the electric vehicle. Thus, all in all, the drive unit can be mounted on the body of the electric vehicle in a simple and inexpensive manner.

Although the present invention has been described above with reference to preferred example embodiments, it is not limited to these but can be modified in many ways.

### INDEXES

1 Drive unit
1a Housing of the drive unit

### 2 Cross-member

3 Longitudinal member
4 Electric motor
5 Torque support
6 Spring link
7 Cardan shaft

### 8 Stabilizer

9 Stabilizer mounting
10 Housing opening

### 11 Profiling

11a Free space
12 Fixing bracket
13 Drive output shaft

### 14 Recess

15 Expansion element

1-14. (canceled)

15. A drive unit (1) for an electric vehicle, the drive unit comprising:
an electric machine (4) for driving the electric vehicle, and the electric machine being arranged in a housing and having a driveshaft (13) for transmitting torque from the electric machine (4) to an axle of the electric vehicle, and
at least one mounting system (2, 3) for mounting the drive unit on a body of the electric vehicle, and the housing (1a) of the drive unit (1) being designed as the mounting system for mounting the drive unit (1) on the body of the electric vehicle.

16. The drive unit (1) according to claim 15, wherein the housing (1a) comprises at least one first fixing means (10) for fixing at least one elastic spring link (6) of the electric vehicle to the housing (1a).

17. The drive unit according to claim 16, wherein the at least one first fixing means (10) is designed for fixing an elastic through-going spring link (6) to the housing.

18. The drive unit according to claim 16, wherein the first fixing means (10) comprise a conically shaped opening (10) which receives the spring link (6), and the conically shaped opening tapers outwardly in a direction toward the inside of the housing (1a).

19. The drive unit according to claim 16, wherein the first fixing means (10) is designed to receive the spring link (6) by insertion.

20. The drive unit according to claim 16, wherein the first fixing means (10) is designed for fixing a spring link (6) made of a fiber-elastic composite material.

21. The drive unit according to claim 16, wherein a plurality of first fixing means (10) is arranged substantially parallel to the driveshaft (13) of the electric machine and arranged either one above another or offset relative to one another.

22. The drive unit according to claim 15, wherein the housing (1a) has second fixing means (14) for fixing the drive unit to a cross-member (2) of the electric vehicle.

23. The drive unit according to claim 22, wherein the second fixing means (14) fixes the drive unit to the cross-member (2) by at least one of an interlock and friction connection.

24. The drive unit according to claim 15, wherein the housing has a torque support (5) that projects from the housing perpendicularly relative to the driveshaft of the electric machine.

25. The drive unit according to claim 24, wherein the torque support (5) comprises a rubber sleeve joint which fixes a stabilizer (8) of the electric vehicle.

26. The drive unit according to claim 25, wherein the sleeve joint has recesses.

27. A method of fixing a drive unit (1) in an electric vehicle, the drive unit has an electric machine (4) for driving the electric vehicle, the electric machine is arranged in a housing and has a driveshaft (13) for transmitting torque from the electric machine (4) to an axle of the electric vehicle, and at least one mounting system (2, 3) for mounting the drive unit on a body of the electric vehicle, the housing (1a) of the drive unit (1) is designed as the mounting system for mounting the drive unit (1) on the body of the electric vehicle, the method comprising the steps of:
inserting at least one spring link (6) into a recess (10) of the housing (1a) of the drive unit (1), and
fixing the at least one spring link (6) in the recess (10) by at least one of bracing the spring link in the recess (10) and by screwing on a plate.

28. The drive system for an electric vehicle in combination with a drive unit that comprises an electric machine (4) for driving the electric vehicle, the electric machine is arranged in a housing and has a driveshaft (13) for transmitting torque from the electric machine (4) to an axle of the electric vehicle, and at least one mounting system (2, 3) for mounting the drive unit on a body of the electric vehicle, the housing (1a) of the drive unit (1) is designed as the mounting system for mounting the drive unit (1) on the body of the electric vehicle, the body of the electric vehicle having at least one torsionally rigid cross-member (2) on which the housing (1a) of the drive unit (1) is fixed, the drive unit comprises a torque support (5) that is fixed on a stabilizer (8) essentially at a center of the stabilizer, and a spring link (6) is fixed on the housing (1a) of the drive unit (1).
